(19) United States
(12) Patent Application Publication
(10) Pub. No.: US 2006/0043026 A1
(43) Pub. Date: Mar. 2, 2006

(54) Method and apparatus for fluid purification

(76) Inventors: Sui-Chun Law, Kowloon (CN); Yiu-Wai Chan, TinShui Wai (CN)

Correspondence Address: CHARLES E. BAXLEY, ESQ., 90 JOHN STREET, THIRD FLOOR, NEW YORK, NY, 10038, US

(21) Appl. No.: 11/202,752

(22) Filed: Aug. 12, 2005

(30) Foreign Application Priority Data
Aug. 31, 2004 (CN) 200420089377.0
Nov. 26, 2004 (CN) 200410091762.3

(51) Int. Cl. C02F 1/72

(52) U.S. Cl. 210/758

(57) ABSTRACT

The present invention provides a method and an apparatus for fluid purification with a good purification effect. The working principle of the purification method is that, when a fluid containing organic pollutants and inorganic impurities flows through an oxidizing reagent generating device and a molecular sieve, wherein said oxidizing reagent generating device is located at an upstream position of said molecular sieve, the oxidizing agents generated by said oxidizing reagent generating device, organic pollutants and inorganic impurities of the fluid are adsorbed into the pores of said molecular sieve, in which said organic pollutants of the fluid are oxidized and decomposed by said oxidizing agents. With this invention, it is not necessary to replace the molecular sieve frequently.

### CROSS-REFERENCE TO RELATED APPLICATION

This application claims priority of CN Patent Application No. 200420089377.0 filed on Aug. 31, 2004, entitled “Apparatus For Fluid Purification”, and CN Patent Application No. 200410091762.3 filed on Nov. 26, 2004, entitled “Method and Apparatus For Fluid Purification”, which are incorporated herein by reference for all purposes.

### TECHNICAL FIELD

The present invention relates to environment protection, and more particularly, to methods and apparatus for purifying fluid, such as air or water.

### BACKGROUND OF THE INVENTION

In the current methods for purifying air or water, oxidizing agents such as ozone or hydroxyl radicals generated by ozone generators or ionizers or other oxidizing agent generation device are usually used to destroy or decompose organic pollutants, for example, bacteria and organic compounds, in air or water. Therefore, ozone generators or ionizers are widely employed to purify different fluids, such as drinking water, aqueous sewage and air, etc. Tests have showed that in the above methods for purifying fluids such as water or air, efficiency of oxidizing the pollutants is usually related to the concentrations of ozone and hydroxyl radicals in fluid. If ozone or hydroxyl radicals are released directly into fluid, the concentration of ozone or hydroxyl radicals will be diluted by fluid, and the purification effectiveness is limited. If the concentration of oxidizing agents such as ozone or hydroxyl radicals is enhanced, ozone or hydroxyl radicals will oxidize other non-pollutant molecules in fluid, and the high concentration of oxidizing agent is harmful and dangerous to human body. Therefore, general ozone generators or ionizers are not safe and effective for purifying water or air.

In the current methods for purifying water or air, high porosity materials, referred as “molecular sieve”, such as zeolite, microporous or nanoporous oxide materials or activated carbon, are also used to purify air or water by effectively adsorbing harmful pollutants in fluid, such as organic pollutants or inorganic impurities. Tests have showed that upon correct selection of molecular sieve based on the shape, orientation, size, hydrophilicity of pollutants, the pollutants, such as organic compounds, in fluid can be effectively filtered and adsorbed. Molecular sieves are very useful for materials because of its low cost of production and capability of regeneration by heating. However, the process of regenerating molecular sieve by heating is not convenient, and in practice, the operation of apparatus for fluid purification has to be shutdown after the molecular sieve is worn out, or several sets of molecular sieves are needed for replacement.

### SUMMARY OF THE INVENTION

The problems to be solved in this invention are as follows: in the method of purifying fluid solely with oxidizing agents to decompose the harmful pollutants, the purification effect is limited due to dilution, or risk may exist for human body due to leakage of oxidizing agent; and, in the method of purifying fluid solely with molecular sieve of high porosity materials, such as zeolite, microporous or nanoporous oxide materials or activated carbon, to filter and adsorb pollutants in fluid, it is necessary to regenerate or replace the molecular sieve frequently on a regular basis. The present invention provides a method and an apparatus for purifying fluid that not only use oxidizing agents to effectively decompose harmful pollutants such as bacteria and organic compounds, but also use molecular sieve to filter and adsorb the pollutants in fluid, so that, it is not necessary to replace molecular sieve frequently, and the risk of leakage of oxidizing agents is reduced.

According to this invention, a method for fluid purification is provided, comprising following steps:

making a fluid containing organic pollutants and inorganic impurities to flow through an oxidizing reagent generating device and a molecular sieve, wherein said oxidizing reagent generating device is located at an upstream position of said molecular sieve;

allowing the oxidizing agents generated by said oxidizing reagent generating device, organic pollutants and inorganic impurities of the fluid to be adsorbed into the pores of said molecular sieve, in which said organic pollutants of the fluid are oxidized and decomposed by said oxidizing agents.

The material of the molecular sieve may contain chemical with composition as (Si^{IV}—O—Al^{III}—O—Si^{IV})⁻H⁺ or (Si^{IV}—O—Al^{III}—O—Si^{IV})⁻M⁺ □ an alumino-silicate with negatively charged, hydrophilic framework containing ion exchange sites or acid sites.

The material of the molecular sieve may contain chemical with composition as (Si^{IV}—O—Si^{IV}—O—Si^{IV})□a silicate with neutral charged, hydrophobic framework containing no ion exchange sites or acid sites.

The material of the molecular sieve may contain chemical with composition as (Al^{III}—O—P^{V}—O—Al^{III})□ an aluminophosphate with neutral charged, hydrophilic framework containing no ion exchange sites or acid sites.

The material of the molecular sieve may contain mixed organic-inorganic oxide framework, which may be made by mixing organic template during the process of synthesis.

The material of the molecular sieve may contain active sites, such as acid sites or redox-active sites, for catalyzing the decomposition reaction of the organic pollutants of the fluid.

The material of the molecular sieve may contain transition metal integrated during ion exchange process or during synthesis.

The material of the molecular sieve may contain chemical with composition as hybrid organic-inorganic oxide framework, wherein said hybrid organic-inorganic oxide framework having organic compounds which may form crystalline structure of said framework, or may form templates for supporting some of the nano-pores of said melocular sieves.

The material of the molecular sieve may be selected from activated carbon, microporous and nanoporous oxide materials or other high porosity materials of the like.

The material of the molecular sieve may be selected from the mixture of activated carbon, microporous and nanoporous oxide materials or other similar high porosity materials mixed with activated carbon.

The material of the molecular sieve has similar hydrophilicity or hydrophobicity as the oxidizing agents generated by said oxidizing reagent generating device; and the pores of the molecular sieve have similar shape and orientation as the molecules of the oxidizing agents generated by the oxidizing reagent generating device.

The molecular sieve contains two-dimension or three-dimension oxide framework.

The oxidizing agents generated by the oxidizing reagent generating device are homogeneous or heterogeneous in comparing with the nature of the fluid.

When the fluid is a liquid, the oxidizing agents generated by said oxidizing reagent generating device may be either in the form of liquid or gas, may be either homogenerous or heterogenerous as the fluid, or may be combination thereof.

When the fluid is a gas, a water scrubbing device is further installed at the upstream position of the molecular sieve. Disinfectant or oxidizing agent is further added into the water of the water scrubbing device.

An apparatus for fluid purification comprises a housing having an outlet and an inlet for the fluid, an oxidizing reagent generating device, a molecular sieve and a circulating device are installed inside said housing, wherein said oxidizing reagent generating device is located at an upstream position of said molecular sieve, and wherein said circulating device facilitates said fluid to flow from upstream to downstream.

The fluid is a water flow; the circulating device is a water pump which pumps water of said water flow from upstream to downstream.

The fluid is an air flow, the circulating device is an exhaust fan which extracts air of said air flow from upstream to downstream. A water scrubbing device is further installed at an upstream position of the molecular sieve.

The oxidizing reagent generating device may be either an ozone generator or an ionizer, or a UV sterilizer, or an electrostatic precipitator.

The apparatus for fluid purification further includes a pre-filter installation at an upstream position of the molecular sieve. The pre-filter may be selected from a cellulose fiber, a HEPA filter, an aluminum filter frame or an electrostatic precipitator. A control unit with particulate sensing unit shall be integrated when the electrostatic precipitator is used as the pre-filter. A by-passing unit for the fluid purification shall be activated automatically to prevent the molecular sieve from surface-clogging with particulates when the particulates level of the in-take fluid is too high, wherein said by-passing unit shall automatically turn off when the particulates level of the in-take fluid is back to normal level.

A heater, a thermal storage device, a UV light or a dehumidifier may be further installed at an upstream position of the pre-filter.

The materials of said molecular sieve are the same as those of the molecular sieve used in the above-mentioned method for fluid purification.

In the apparatus and the method for fluid purification of the present invention, the oxidizing agents generated from the oxidizing reagent generating device, together with organic pollutants and inorganic impurities in the fluid can be adsorbed into pores of the molecular sieve. Since the oxidizing agents and the organic pollutants are confined inside the pores of molecular sieve, a catalytic effect is then produced, and a good purification effect is achieved. Moreover, since the oxidizing agents have similar properties, such as shape, size, hydrophilicity, hydrophobicity, as those of materials of molecular sieve, excessive oxidizing agents can be adsorbed into pores of molecular sieve, thereby leakage of oxidizing agents can be prevented. With this method or apparatus for fluid purification, since the oxidizing agents decompose the pollutants adsorbed inside the pores of molecular sieve, it is not necessary to replace the molecular sieve frequently.

### BRIEF DESCRIPTION OF DRAWINGS

FIG. 1 is a schematic diagram showing the working principle of the method for fluid purification of this invention, in which oxidizing agents, organic pollutants and inorganic impurities are adsorbed into the pores of the molecular sieve;

FIG. 2 is a schematic diagram showing the apparatus for fluid purification of this invention;

FIG. 3 is a schematic diagram showing another apparatus for fluid purification of this invention;

FIG. 4 is a schematic diagram showing still another apparatus for fluid purification of this invention;

FIG. 5 is a schematic diagram showing the apparatus for fluid purification of this invention comprising a water scrubbing device;

FIG. 6 is a schematic diagram showing the apparatus for fluid purification of this invention comprising another water scrubbing device.

### DESCRIPTION OF THE PREFERRED EMBODIMENTS

The method and apparatus for fluid purification of this invention will be described in combination with the accompanying drawings and embodiments.

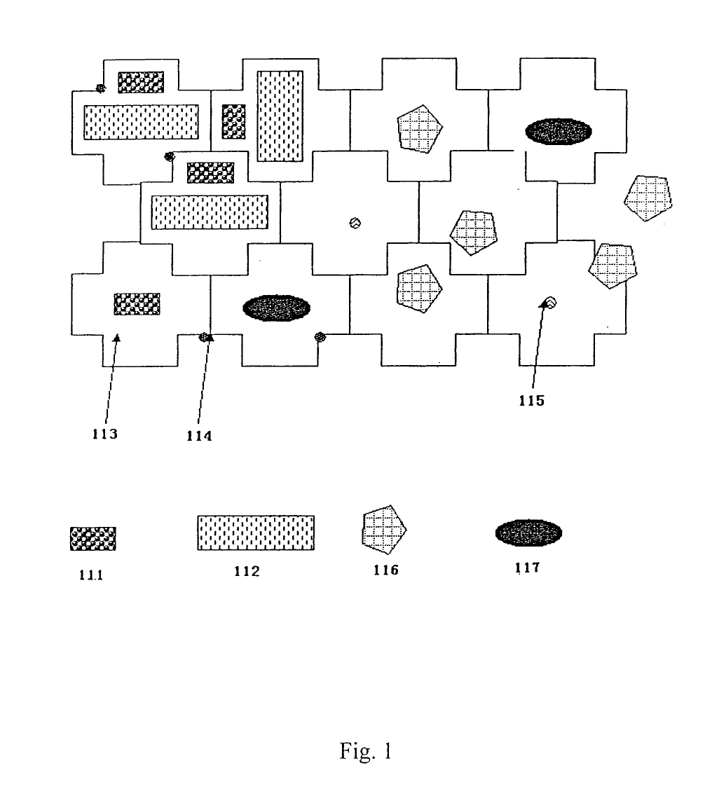

FIG. 1 is the schematic diagram showing the working principle of the method for fluid purification of this invention, in which oxidizing agents, organic pollutants and inorganic impurities are adsorbed into the pores of the molecular sieve. The oxidizing agent 111 generated by the oxidizing reagent generating device is adsorbed into the pores 113 of the molecular sieve together with the organic pollutants 112 in the fluid. The oxidizing agent 111 decomposes the organic pollutants 112 in the pores 113 of the molecular sieve. Inorganic impurities 117 are filtered and adsorbed by the pores 113 of the molecular sieve. Excessive oxidizing agent 111 is also adsorbed into the pores 113 of molecular sieve.

The molecular sieve used in the method for fluid purification of this invention, such as nano-zeloite or other high porosity material of the like, has the following properties:

(1) The material of the molecular sieve may contain chemical with composition as (Si^{IV}—O—Al^{III}—O—Si^{IV})⁻H⁺ or (Si^{IV}—O—Al^{III}—O—Si^{IV})⁻M⁺, an alumino-silicate with negatively charged, hydrophilic framework containing ion exchange sites or acid sites.

(2) The material of the molecular sieve may contain chemical with composition as (Si^{IV}—O—Si^{IV}—O—Si^{IV}), a silicate with hydrophobic, neutral charged framework containing no ion exchange sites or acid sites.

(3) The material of the molecular sieve may contain chemical with composition as (Al^{III}—O—^{PV}—O—Al^{III}), an aluminophosphate with hydrophilic, neutral charged framework containing no ion exchange sites or acid sites.

(4) The material of the molecular sieve may contain mixed organic-inorganic oxide framework, which may be made by mixing organic template during the process of synthesis.

(5) The material of the molecular sieve may contain active sites, such as acid sites or redox-active sites, for catalyzing the decomposition reaction of the organic pollutants of the fluid.

(6) The material of the molecular sieve, such as the nanoporous and microporous oxide materials or other high porosity material of the like, may contain transition metals integrated during ion exchange process or during synthesis. When they are integrated into the oxide framewok during ion exchange process, the transition metals are in the form of cation. When they are integrated into the oxide framework during synthesis, the transition metals form the structure of the oxide framework.

(7) The molecular sieve, such as microporous and nanoporous oxide materials or other high porosity material of the like, may contain hybrid organic-inorganic oxide framework, wherein said hybrid organic-inorganic oxide framework having organic compounds which may form structure molecules of said framework, or may form templates for supporting of the nano-pores of said molecular sieve, which are structurally required for forming a particular crystalline structure of the organic-inorganic oxide frame work.

(8) The molecular sieve, such as microporous and nanoporous oxide materials or other high porosity material of the like, may be replaced by activated carbon, or may be replaced by the mixture of the molecular sieve, microporous and nanoporous oxide materials or other similar high porosity materials with activated carbon.

The oxidizing agent 111 generated by the oxidizing reagent generating device, and organic pollutants 112 in fluid have similar hydrophilicity or hydrophobicity as the material of the molecular sieve, and have similar shape, orientation as the pores of the molecular sieve. The oxidizing agent and the organic pollutants may be homogeneous or heterogeneous in comparing with the nature of the fluid. This is ensured that both of oxidizing agent 111 and organic pollutants 112 can be adsorbed into the pores 113 of the molecular sieve and it is also ensured that excessive oxidizing agent 111 can be adsorbed into the pores 113 of molecular sieve.

The materials of the molecular sieve are provided with active oxidative or redox sites. They may contain two-dimension or three-dimension oxide framework. They may contain oxidative or redox metals such as transition metals, which form structure molecules 114 of the oxide framework, and which may occupy the pores of the molecular sieve, such as nano-zeloite or other high porosity material of the like, in the form of cations 115. Other additives such as aromatic chemical molecules, like the non-target organic compounds 116, are not decomposed in this system and are discharged to a downstream position.

### Embodiment 1

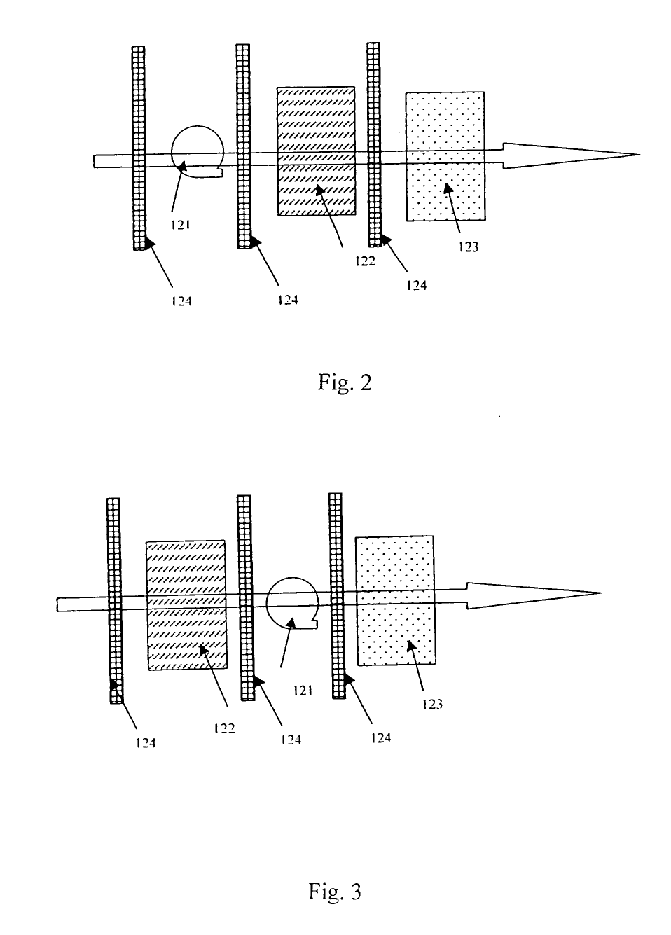

As shown in FIG. 2, in the embodiment 1 of the present invention, the apparatus can be employed as an air treatment system or a water treatment system. In this system, a pump or fan 121 is located at an upstream position of the oxidizing reagent generating device 122 and the microporous and nanoporous oxide materials filter 123. At least one pre-filter 124 should be installed in the fluid purification system to remove larger size particles and to prevent of clogging of the microporous and nanoporous oxide materials filter 123.

### Embodiment 2

As shown in FIG. 3, in the embodiment 2 of the present invention, this apparatus can be employed as an air treatment system or a water treatment system. In this system, a pump or fan 121 is located between the oxidizing reagent generating device 122 and the microporous and nanoporous oxide materials filter 123. The pump or fan 121 should be made of anticorrosive and antioxidative materials. Thus, the pump or fan 121 will not be damaged by the oxidizing agents generated at an upstream position. At least one pre-filter 124 should be installed in the fluid purification system to remove larger size particles and to prevent of clogging of the microporous and nanoporous oxide materials filter 123.

### Embodiment 3

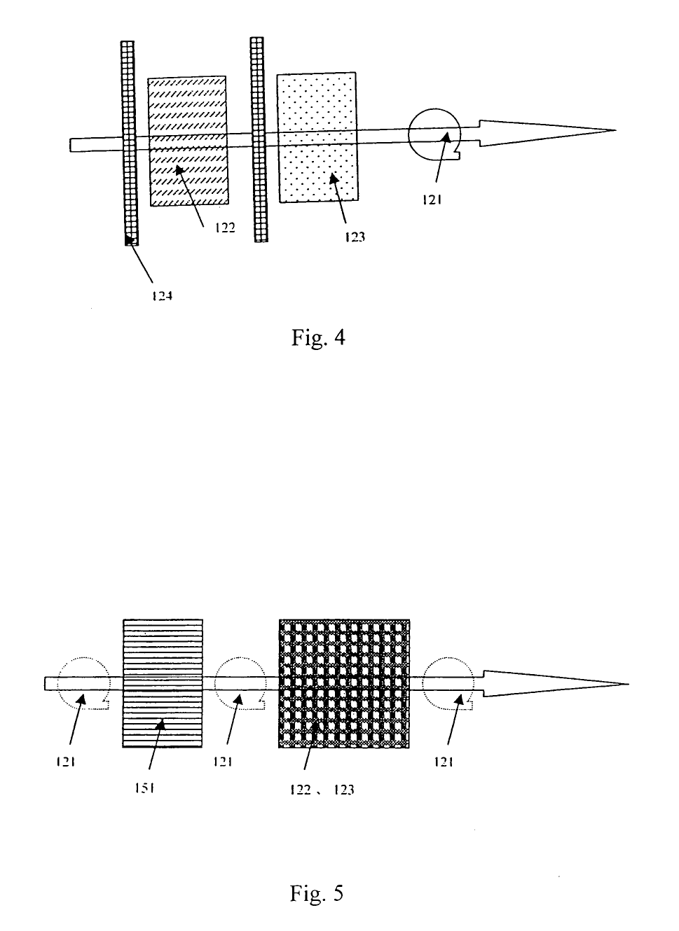

As shown in FIG. 4, in the embodiment 3 of the present invention, this apparatus can be employed as an air treatment system or a water treatment system. In this system, a pump or fan 121 is located at a downstream position of the oxidizing reagent generating device 122 and the microporous and nanoporous oxide materials filter 123. At least one pre-filter 124 should be installed in this system to remove larger size particles and to prevent of clogging of the microporous and nanoporous oxide materials filter 123.

### Embodiment 4

As shown in FIG. 5, in the embodiment 4 of the present invention, this apparatus can be employed as an air treatment system. In this system, a water scrubbing device 151 is located at an upstream position of the oxidizing reagent generating device 122 and the Zeolite filter 123. The pump or fan 121 shall be installed at any location of the system. The motor of the pump or fan 121 should be able to endure the total wind resistance and pressure of the whole system. Large size particles shall be removed with the water scrubbing device. Disinfectants or other additives may also be added into the solution in the water scrubbing device.

### Embodiment 5

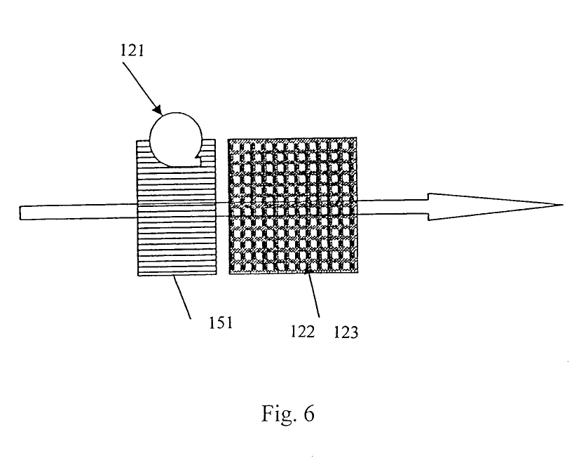

As shown in FIG. 6, in the embodiment 5 of the present invention, this apparatus is employed as an air treatment system. In this system, a water scrubbing device 151 is integrated with a pump or fan 121 by one single motor. The water scrubbing device 151 and the pump or fan 121 are located at an upstream position of the oxidizing reagent generating device 122 and the zeolite filter 123. The motor of the pump or fan 121 should be able to endure the total wind resistance and pressure of the whole system. The water scrubbing device can remove large size particles of the fluid. Disinfectants or other additives may also be added into the solution in the water scrubbing device.

In the above-mentioned embodiments, the fan 121 may be replaced by a centrifugal fan or an axial fan. The pump or fan is required to generate a pressure overcoming the total pressure loss of the whole fluid purification system. The pre-filter 124 is used to remove various size of particles and may be replaced by a cellulose fiber, a HEPA filter, an aluminum filter frame or the combination thereof. A heater, a thermal storage device, a UV light or a dehumidifier may be integrated at an upstream position of the fluid purification system of this invention.

Non-target organic compounds, such as aromatic additives or other additives, may be added into the apparatus for fluid purification, which will not be oxidized in the apparatus for fluid purification.

What is claimed is:

1. A method for fluid purification, comprising following steps:
making a fluid containing organic pollutants and inorganic impurities to flow through an oxidizing reagent generating device and a molecular sieve, wherein said oxidizing reagent generating device is located at an upstream position of said molecular sieve;
allowing the oxidizing agents generated by said oxidizing reagent generating device, organic pollutants and inorganic impurities of the fluid to be adsorbed into the pores of said molecular sieve, in which said organic pollutants of the fluid are oxidized and decomposed by said oxidizing agents.

2. The method for fluid purification according to claim 1, wherein, the material of said molecular sieve comprises (Si^{IV}—O—Al^{III}—O—Si^{IV})⁻H⁺ or (Si^{IV}—O—Al^{III}—O—Si^{IV})⁻M⁺, an alumino-silicate with negatively charged, hydrophilic framework containing ion exchange sites or acid sites.

3. The method for fluid purification according to claim 1, wherein, the material of said molecular sieve may contain chemical with composition as (Si^{IV}—O—Si^{IV}—O—Si^{IV}), a silicate with neutral charged, hydrophobic framework containing no ion exchange sites or acid sites.

4. The method for fluid purification according to claim 1, wherein, the material of said molecular sieve may contain chemical with composition as (Al^{III}—O—P^{V}—O—Al^{III}), an aluminophosphate with neutral charged, hydrophilic framework containing no ion exchange sites or acid sites.

5. The method for fluid purification according to claim 1, wherein, the material of said molecular sieve contains mixed organic-inorganic oxide framework, which may be made by mixing organic template during the process of synthesis.

6. The method for fluid purification according to claim 1, wherein, the material of said molecular sieve contains active sites, such as acid sites or redox-active sites, for catalyzing the decomposition reaction of the organic pollutants of the fluid.

7. The method for fluid purification according to claim 1, wherein, the material of said molecular sieve contains transition metal integrated during ion exchange process or during synthesis.

8. The method for fluid purification according to claim 1, wherein, the material of said molecular sieve contains hybrid organic-inorganic oxide framework, wherein said hybrid organic-inorganic oxide framework having organic compounds which may form crystalline structure of said framework, or may form templates for supporting some of the nano-pores of said molecular sieve.

9. The method for fluid purification according to claim 1, wherein, the material of said molecular sieve may be selected from activated carbon, microporous and nanoporous oxide materials or other high porosity materials of the like.

10. The method for fluid purification according to claim 1, wherein, the material of said molecular sieve may be selected from the mixture of activated carbon with microporous and nanoporous oxide materials or other similar high porosity materials.

11. The method for fluid purification according to claim 1, wherein, the material of said molecular sieve has similar hydrophilicity or hydrophobicity as the oxidizing agents generated by said oxidizing reagent generating device; and the pores of said molecular sieve have similar shape and orientation as the molecules of the oxidizing agents generated by the oxidizing reagent generating device.

12. The method for fluid purification according to claim 1, wherein, said molecular sieve contains two-dimension or three-dimension oxide framework.

13. The method for fluid purification according to claim 1, wherein, the oxidizing agents generated by said oxidizing reagent generating device are homogeneous or heterogeneous in comparing with the nature of the fluid.

14. The method for fluid purification according to claim 1, wherein, when the fluid is a liquid, the oxidizing agents generated by said oxidizing reagent generating device may be either in the form of liquid or gas, may be either homogenerous or heterogenerous as the fluid, or may be combination thereof.

15. The method for fluid purification according to claim 1, wherein, when the fluid is a gas, a water scrubbing device is further installed at the upstream position of said molecular sieve.

16. The method of fluid purification according to claim 15, wherein, disinfectant or oxidizing agent is further added into the solution in the water scrubbing device.

17. An apparatus for fluid purification, comprising:
a housing having an outlet and an inlet for the fluid;
an oxidizing reagent generating device;
a molecular sieve; and
a circulating device;
wherein said oxidizing reagent generating device, molecular sieve and circulating device are installed inside said housing, and wherein said oxidizing reagent generating device is located at an upstream position of said molecular sieve, and wherein said circulating device facilitates said fluid to flow from upstream to downstream.

18. The apparatus for fluid purification according to claim 17, wherein, said fluid is a water flow; said circulating device is a water pump which pumps water of said water flow from upstream to downstream.

19. The apparatus for fluid purification according to claim 17, wherein, said fluid is an air flow, said circulating device is an exhaust fan which extracts air of said air flow from upstream to downstream.

20. The apparatus for fluid purification according to claim 17, wherein, a water scrubbing device is further installed at an upstream position of said molecular sieve.

21. The apparatus for fluid purification according to claim 17, wherein, said oxidizing reagent generating device may be either an ozone generator or an ionizer.

22. The apparatus for fluid purification according to claim 17, further includes a pre-filter installation at an upstream position of said molecular sieve.

23. The apparatus for fluid purification according to claim 22, wherein, the pre-filter may be selected from a cellulose fiber, a HEPA filter, an aluminum filter frame or an electrostatic precipitator or the mixture of thereof.

24. The apparatus for fluid purification according to claim 22, wherein, a heater, a thermal storage device, a UV light or a dehumifier may be further installed at an upstream position of the pre-filter.

25. The apparatus for fluid purification according to claim 17, wherein, the material of said molecular sieve may contain chemical with composition as (Si^{IV}—O—Al^{III}—O—Si^{IV})⁻H⁺ or (Si^{IV}—O—Al^{III}—O—Si^{IV})⁻M⁺, an alumino-silicate with negatively charged, hydrophilic framework containing ion exchange sites or acid sites.

26. The apparatus for fluid purification according to claim 17, wherein, the material of said molecular sieve may contain chemical with composition as (Si^{IV}—O—Si^{IV}—O—Si^{IV}), a silicate with neutral charged, hydrophobic framework containing no ion exchange sites or acid sites.

27. The apparatus for fluid purification according to claim 17, wherein, the material of said molecular sieve may contain chemical with composition as (Al^{III}—O—P^{V}—O—Al^{III}), an aluminophosphate with neutral charged, hydrophilic framework containing no ion exchange sites or acid sites.

28. The apparatus for fluid purification according to claim 17, wherein, the molecular sieve contains mixed organic-inorganic oxide framework, which may be made by mixing organic template during the process of synthesis.

29. The apparatus for fluid purification according to claim 17, wherein, the material of said molecular sieve contains active sites, such as acid sites or redox-active sites, for catalyzing the decomposition reaction of the organic pollutants of the fluid.

30. The apparatus for fluid purification according to claim 17, wherein, the material of said molecular sieve contains transition metal integrated during ion exchange process or during synthesis.

31. The apparatus for fluid purification according to claim 17, wherein, the material of said molecular sieve contains hybrid organic-inorganic oxide framework, wherein said hybrid organic-inorganic oxide framework having organic compounds which may form crystalline structure of said framework, or may form templates for supporting some of the nano-pores of said melocular sieves.

32. The apparatus for fluid purification according to claim 17, wherein, the material of said molecular sieve may be selected from activated carbon, microporous and nanoporous oxide materials or other high porosity materials of the like.

33. The apparatus for fluid purification according to claim 17, wherein, the material of said molecular sieve may be selected from the mixture of activated carbon and microporous and nanoporous oxide materials or other similar high porosity materials mixed with activated carbon.

34. The apparatus for fluid purification according to claim 22, wherein, a control unit with particulate sensing unit shall be integrated when the electrostatic precipitator is used as the pre-filter; and a by-passing unit for the fluid purification shall be activated automatically to prevent the molecular sieve from surface-clogging with particulates when the particulates level of the in-take fluid is too high, wherein said by-passing unit shall automatically turn off when the particulates level of the in-take fluid is back to normal level.

35. The apparatus for fluid purification according to claim 23, wherein, a control unit with particulate sensing unit shall be integrated when the electrostatic precipitator is used as the pre-filter; and a by-passing unit for the fluid purification shall be activated automatically to prevent the molecular sieve from surface-clogging with particulates when the particulates level of the in-take fluid is too high, wherein said by-passing unit shall automatically turn off when the particulates level of the in-take fluid is back to normal level.
